(19) United States
(12) Patent Application Publication
(10) Pub. No.: US 2005/0141792 A1
(43) Pub. Date: Jun. 30, 2005

(54) Oil-carrying single bearing unit

(76) Inventor: Mou-Kun Chen, Jhonghe City (TW)

Correspondence Address: Mou-Kun Chen, P. O. Box No. 6-57, Junghe, Taipei, 235, TW

(21) Appl. No.: 10/745,493

(22) Filed: Dec. 29, 2003

(51) Int. Cl. F16C 1/00; F16C 1/24; F16C 3/14; F16C 5/00; F16C 33/10; F16C 33/16

(52) U.S. Cl. 384/322

(57) ABSTRACT

An oil-carrying single bearing unit, characterized in providing a simply structured single bearing that is configured to effect self-lubrication, and especially claims achieving advancement in safety design between moving components. The oil carrying single bearing unit primarily comprises an axle center pivoted within an axle sleeve, and adapted for load bearing thereon. More particularly, an oil receptacle is configured within the axle sleeve, and functions to store oil therein. Agitating sites with functionality to agitate the oil receptacle are configured on a section of the journal of the axle center relative to position of the oil receptacle, and afford a safety design aspect to the axle, as well as simply and conveniently achieving a configuration with lubrication functionality.

### BACKGROUND OF THE INVENTION

(a) Field of the Invention

The present invention relates to an oil-carrying single bearing unit, and more particularly to providing a miniature bearing unit of a bearing unit for high speed running and light loading, and a design that furnishes a bearing unit with safety and simplicity.

(b) Description of the Prior Art

Among related bearing mechanisms, in order to minimize frictional wear and tear of running pivots, bearings are required and employed to provide support at a center of rotating components and realize lubricating assistance there between. The bearings employed include radial bearings and thrust bearings (the present invention applies to radial bearings). The bearings are configured in various formats in accordance with requirements of loading and rotating speed, and demands of mechanism specifications.

Ball bearings or roller bearings are employed as a form of support for the loading, and to separate a rotating axle center from a bearing block of a peripheral component. When the loading is of a light nature, because load to bear is slight, hence a simply constructed single bearing is employed.

Further related to single bearing mechanisms, apart from tradition in a bearing sleeve, wherewith additionally supplies an oil filling method to maintain distribution of an oil film. The oil film is distributed to rubbing interfacial surfaces of a journal and a bushing, thereby achieving functionality of lubrication.

In order to make it unnecessary to provide follow-up additional supplying of a lubricating oil agent, bearing mechanisms can further employ a hermetic sealing type bearing, and can employ a centrifugal-type hydraulic pressure bearing in accordance with application specifications.

The hydraulic pressure bearing primarily utilizes gyration moment of force of the axle center to correlate oil material mass, and thus form a force of inertia thereof. When rotating, a component force of inertia presses the oil material, and thereby fills a pivot joint interfacial surface of the journal and bearing block.

Furthermore, cohesive forces and adhesive forces of the oil film enable the oil material on members of the mechanism to maintain lubrication within interspaces, but without causing oil spillage. Even when a congregation of the oil material results from the adhesive forces being greater than the interspacing of the pivot joint, the oil material is maintained within a bearing unit.

However, as for design of such related conventional hydraulic pressure bearing devices, referring to FIG. 7, which shows a conventional bearing device utilizing an axle center 3 pivoted within a bushing 4, an inner oil receptacle 31 is defined within the axle center 3, and an oil plug 311 seals up an end opening.

A channel 32 is configured at a position relative to location of the journal. Firstly, the oil receptacle 31 is filled with the lubricating oil material through the end opening, and thereupon is sealed with the oil plug 311. Various designs simply enable applying oil to a location at a bearing end, and do not facilitate realizing lubrication at center of an axial shaft. Upon the axle center 3 of such a convention hydraulic pressure bearing device rotating, an inertial centrifugal force is thereby generated having a moment of force effect that multiplies mass, and therewith the oil material of the oil receptacle 31 is directed towards and carried through the channel 32 onto the pivot joint interfacial surface of the journal and the bushing 4, thereby lubricating the interfacial surface. A centrifugal force effect perpendicular to the channel 32 facilitates outwardly pressing the oil material within the oil receptacle 31. When rotating is shut down, the oil material accumulated within the channel 32 will, because of elimination of the centrifugal force, and by means of a gyration centrifugal pressure, hence back-flows into the oil receptacle 31, thereby achieving reclaiming of the lubricating oil material from the axle center 3 and the bushing 4. However, various design formats only implement lubrication delivery methods that carry oil to an end of the axle center, and thus makes it impossible to realize lubricating of a central location of the axle center. Furthermore, because the oil receptacle 31 is configured as a hollow at one end of the axle center 3, and thus impairs mechanical strength of the axle center 3.

Furthermore, if a conventional bearing device is employed in a miniature scale setting, difficulty in manufacturing specifications is very high, and processing of the configured channel 32 is similarly difficult.

### SUMMARY OF THE INVENTION

In conclusion, because of the various aforementioned shortcomings, the present invention particularly provides a safe and simple oil-carrying single bearing suitable for actualizing lubrication of any location on an axle shaft, and thus realizing a beneficial result of wide-ranging application.

A primary objective of the present invention is to utilize an axle center pivoted in an axle sleeve, having an oil receptacle defined within the axle sleeve. Agitating sites are configured on a journal of the axle center, whereby the agitating sites agitate oil, and thereby forms a divided pressure to evenly flood oil within an inner cylindrical oil receptacle of the axle sleeve, realizing effortless effectiveness and beneficial result of actualizing lubrication of any location on the axle shaft.

Another objective of the present invention is in the agitating sites configured on the journal, whereby distribution of a plurality of staggered agitating sites can be arranged and configured in accordance with length and area of the oil receptacle.

A third objective of the present invention is in a radial cylindrical surface of the inner cylindrical oil receptacle configured in the axle sleeve, which can be further defined to form annular ribs, thereby providing a larger endothermic area, and realizing a divided pressure effect relative to the agitating sites.

A fourth objective of the present invention is in a radial outer cylindrical surface of the axle sleeve, which can be further configured with heat dissipating fins in accordance with Installation specifications of a machine housing, thereby preventing overheating of each component or, because of overheating, averting easy expansion and vaporization of a lubricating oil agent.

A fifth objective of the present invention is in the journal of the axle center, which can be further configured with inner annular grooves, whereby protruding annular ribs relative to the inner annular grooves can be formed to differ in length and thus define different radiuses. Upon the axle center rotating, the inner annular grooves thereby facilitate producing different inertial moment of forces, and enhance agitating flow effect therefrom.

A sixth objective of the present invention is in the agitating sites, which can be configured in any form, wherein the agitating sites are configured as narrow slot forms, or configured as groove-type holes, whereby the holes are drilled out by means of any drilling method available.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cross sectional view of a basic embodiment according to the present invention.

FIG. 2 shows an elevational view of a further embodiment of an axle center according to the present invention.

FIG. 3 shows a working schematic diagram of the axle center of FIG. 2 disposed in an axle sleeve according to the present invention.

FIG. 4 shows a cross sectional view of annular ribs configured on an oil receptacle according to the present invention.

FIG. 5 shows a cross sectional view of annular heat dissipating fins configured on an exterior surface of the axle sleeve according to the present invention.

FIG. 6 shows a cross sectional view of annular ribs configured on a journal according to the present invention.

FIG. 7 shows a structural elevational view of a related conventional hydraulic pressure bearing.

### DETAILED DESCRIPTION OF THE PREFERRED EMBODIMENTS

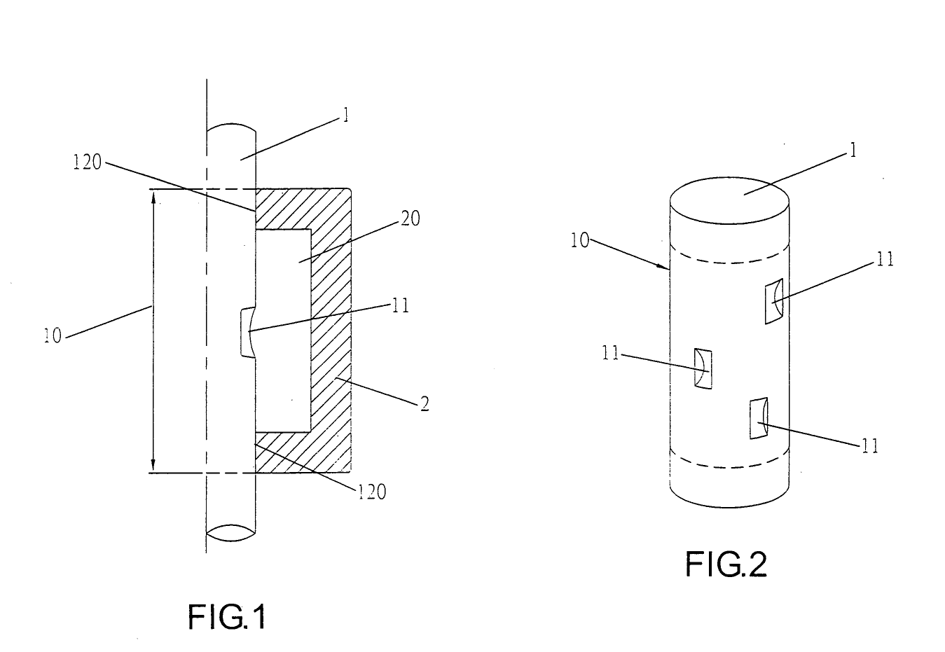

Regarding details of embodiments of an oil-carrying single bearing unit according to the present invention, see FIG. 1, which depicts an embodiment of the oil-carrying single bearing set comprising an axle center 1 and a journal 10 penetrating and positioned in an axle sleeve 2. The aforementioned journal 10 can be positioned at an end of the axle center 1 or on any center location of a shaft itself (the aforementioned axle sleeve 2 is deemed to be in a fixed state, and made from any applicable material available, including materials such as ceramic, metal . . . etc., particularly materials having a high oiliness property).

An annular shaped inner cylindrical oil receptacle 20 is configured as an indentation within the axle sleeve 2. Agitating sites 11 are defined and configured as depressions in the journal 10 relative to the oil receptacle 20. A pivot joint interfacial cylindrical surface 120 is defined between the journal 10 and the axle sleeve 2, and utilized as a tolerance clearance fit, having a clearance precision smaller than that which would allow lubricating film of the oil receptacle 20 to seep through. Therefore, when in a stationary state, oil material cannot leak out from the clearance. Upon the axle center 1 rotating, the agitating sites 11 also begin revolving. The revolving agitating sites 11, apart from gyration agitation of the oil material within the oil receptacle 20, at the same time, because of centrifugal force produced from high-speed rotation of the axle center 1, the oil material within the depressions of the agitating sites 11 is pulled in a direction of the oil receptacle 20, and thereby the oil receptacle 20 produces a positive pressure effect, and this pressure forces the lubricating oil into the interfacial cylindrical surface 120, thereby achieving functionality of lubricating the axle center 1. Hereat, back pressure forms within the depressions of the agitating sites 11, and upon shutting down, the agitating sites 11 provide pressure release for the oil receptacle 20, and the oil material backfills into the agitating sites 11, while the oil material previously forced into the interfacial cylindrical surface 120 is simultaneously forced back into the oil receptacle 20.

The agitating sites 11 can be formed from a nest of crevices, any form of circular apertures or any geometrically formed cutout holes (as long as provision is made for a depression), and allows infilling of the oil material.

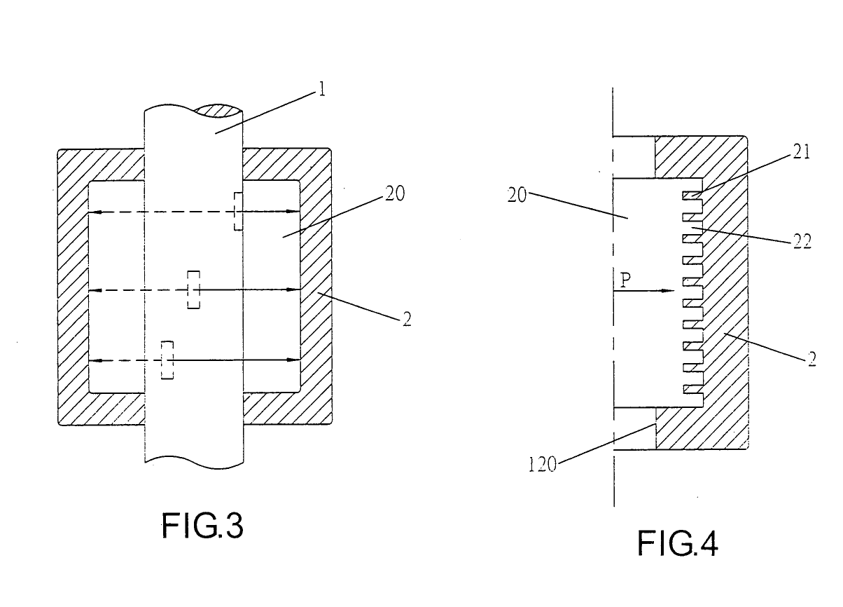

Referring to FIG. 2, which shows a further embodiment of the present invention, and depicts the journal 10 defined on the axle center 1, whereon the agitating sites 11 are configured at any position on a three-dimensional surface of the journal 10 thereof. The plurality of agitating sites 11 defines a staggered arrangement, and the axle sleeve 2, as depicted in FIG. 3, utilizes pressure formed therefrom. The agitating sites 11 can be configured relative to any position of the oil receptacle 20, thereby realizing equalization of pressure at any point on a base of the oil receptacle 20.

Referring to FIG. 4, which shows another embodiment allowing easy heat dissipation of the lubricating oil. Annular grooves 22 are configured at radially correlated positions on an inner cylindrical wall of the inner cylindrical oil receptacle 20 of the axle sleeve 2. Therefrom, annular ribs 21 form between the plurality of annular grooves 22, and distribution of the annular ribs 21 and the annular grooves 22 magnifies a radial cylindrical surface area of the oil receptacle 20, thereby enhancing an endothermic property of the oil-carrying single bearing unit. Therefore, the lubricating oil material can carry away heat generated from friction to external extremities of the axle sleeve 2, and release the heat thereat.

Furthermore, because of presence of the annular ribs 21, an oil pressure P will press against an inner cylindrical surface of the oil receptacle 20, thereby releasing pressure from velocity of axial flow, and transfers direction of hydraulic pressure flow or causes an agitating flow effect. Thereby enhancing damping of the oil material, and preventing the oil material from developing considerable pressure on the interfacial cylindrical surface 120.

Referring to FIG. 5, which shows a further embodiment of the present invention, whereby, in order to rapidly dissipate quantities of heat from the oil-carrying single bearing unit, and under permittable situations that allows deployment of such in machinery, annular heat dissipating fins 23 can be configured on an exterior surface of the axle sleeve 2. Because of heat formed from friction, the annular heat dissipating fins 23 are utilized to rapidly dissipate heat outwards from the oil receptacle 20 or the interfacial cylindrical surface 120.

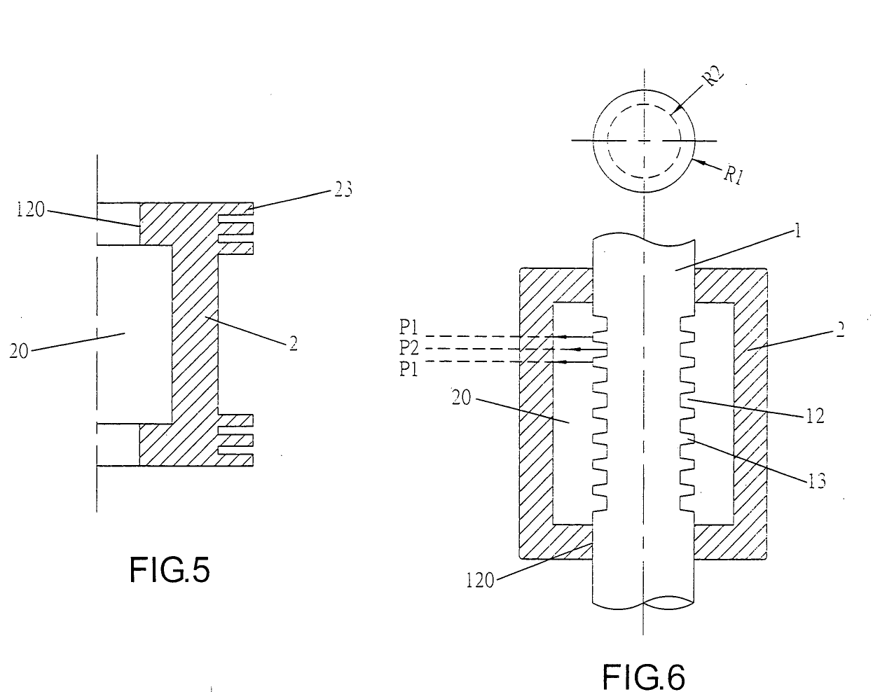

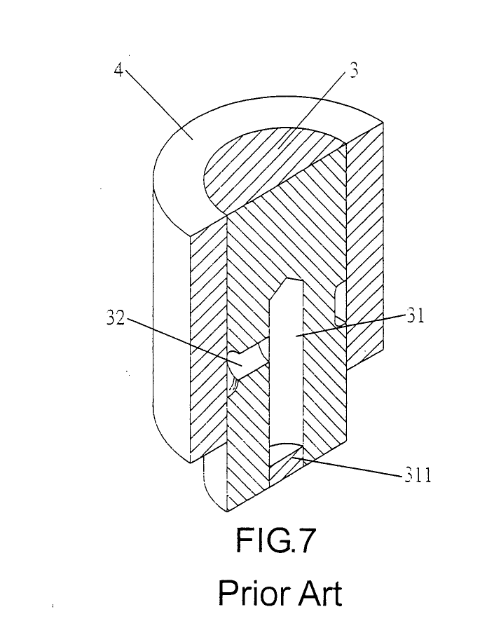

Referring to FIG. 6., for sake of convenience of manufacture processing specifications, and to realize uniform distribution of components of inertial moment of force or because of flow interference, inner annular grooves 12 are configured directly on the journal 10 defined on the axle center 1, and relative to body of the oil receptacle 20 configured to reside within the oil sleeve 2, with corresponding annular ribs 13 defined between the inner annular grooves 12. Upon the axle center 1 rotating, because of different radiuses R1 and R2 formed by the annular ribs 13 and the inner annular grooves 12 respectively, variant pressures P1 and P2 are formed from a disparity of radial complementary rotating velocities. Furthermore, upon the pressure P2, which is smaller than the pressure P1 and separated by and defined between the two adjoining pressures P1, projecting onto the inner cylindrical wall of the oil receptacle 20, a different hydraulic jet pressure is brought about. The comparatively smaller pressure P2 can provide a spacing for the comparatively larger pressure P1 to release pressure therein, thereby dividing pressure on the inner cylindrical wall of the inner cylindrical oil receptacle 20, and uniformly distributing centrifugal pressure between front and rear positions of the oil receptacle 20 thereof. Thus, embodiment as disclosed above is easily manufactured by machine lathing, and, moreover, benefits manufacture processing on any body center position of the axle center 1. Furthermore, the inner annular grooves 12 as configured are multiple distributed, and will therefore not produce any centralized impairment in mechanical strength of the axle center 1. Even upon longitudinal displacement occurring between the axle center 1 and the axle sleeve 2, exterior surfaces of the annular ribs 13 can instantly act as stop locks on relative locations of the interfacial cylindrical surface 120 of the axle sleeve 2, thereby preventing the oil material from completely leaking out.

It is of course to be understood that the embodiments described herein is merely illustrative of the principles of the invention and that a wide variety of modifications thereto may be effected by persons skilled in the art without departing from the spirit and scope of the invention as set forth in the following claims.

1. An oil-carrying single bearing unit, primarily providing an oil-carrying bearing unit of a miniature single bearing unit for high speed running and light loading; characterized in comprising an axle center, and a journal of the axle center pivoted within an axle sleeve, which bears a load thereon, and more particularly, an oil receptacle is configured within the axle sleeve, and agitating sites are defined on the journal of the axle center relative to positioning of the oil receptacle.

2. The oil-carrying single bearing unit as claimed in claim 1, wherein a cylindrical surface of the journal is further configured with a staggered arrangement of agitating sites.

3. The oil-carrying single bearing unit as claimed in claim 1, wherein a radial cylindrical surface of the inner cylindrical oil receptacle configured in the axle sleeve is further configured to form annular ribs.

4. The oil-carrying single bearing unit as claimed in claim 1, wherein a radial outer cylindrical surface of the axle sleeve is further configured with heat dissipating fins.

5. The oil-carrying single bearing unit as claimed in claim 1, wherein the journal of the axle center is further configured with inner annular grooves.

6. The oil-carrying single bearing unit as claimed in claim 1, wherein the agitating sites are further configured as narrow slot forms or any shaped apertures.
